(19) United States
(12) Patent Application Publication
(10) Pub. No.: US 2025/0196494 A1
(43) Pub. Date: Jun. 19, 2025

(54) RECORDING APPARATUS

(71) Applicant: CANON KABUSHIKI KAISHA, Tokyo (JP)

(72) Inventors: HIROSHI KAWAFUJI, Tokyo (JP); MASAKI NITTA, Kanagawa (JP); TAKESHI MURASE, Kanagawa (JP); HIROSHI TAIRA, Tokyo (JP); SAE MOGI, Kanagawa (JP); SHUNNOSUKE KOSEKI, Kanagawa (JP)

(21) Appl. No.: 18/976,073

(22) Filed: Dec. 10, 2024

(30) Foreign Application Priority Data
Dec. 14, 2023 (JP) 2023-211576

(51) Int. Cl. B41J 2/045; B41J 11/00

(52) U.S. Cl. CPC B41J 2/0454; B41J 2/04553; B41J 2/04563; B41J 2/0458; B41J 11/00222

(57) ABSTRACT

A recording apparatus includes a recording head configured to discharge a liquid onto a recording medium to form an image, a heating unit configured to heat the recording medium, a first temperature sensor disposed in the recording head and configured to detect a temperature of the recording head, and a second temperature sensor configured to detect a temperature around the recording head, wherein a correction value for correcting the temperature of the recording head is calculated based on results of detection by the first temperature sensor and the second temperature sensor during a period from when the recording apparatus is powered on to when the heating unit is driven.

### BACKGROUND

### Field of the Disclosure

The present disclosure relates to a recording apparatus.

### Description of the Related Art

There has been conventionally known a recording apparatus that records an image by discharging a liquid onto a recording medium by driving recording elements disposed in a recording head. In such a recording apparatus, it is known that various kinds of control are performed based on a temperature detected by a temperature sensor disposed in the recording head.

As the temperature sensor disposed in the recording head, a diode sensor with excellent thermal responsiveness is generally used. However, diode sensors have variations in characteristics due to manufacturing errors. Since there are cases where a diode sensor detects a temperature different from an actual temperature due to an error from a reference characteristic, measures are taken to correct a detection value. United States Patent Application Publication No. 2002/0041300 discusses a configuration in which a thermistor is disposed on a substrate of a control unit in a recording apparatus body to detect an environmental temperature and correct the detection value from the diode sensor disposed in the recording head based on the detection value of the environmental temperature.

In the configuration of United States Patent Application Publication No. 2002/0041300, it is a prerequisite that the temperature of the recording head is substantially equal to the environmental temperature in order to accurately calibrate the temperature of the recording head. Therefore, in a recording apparatus equipped with a heating mechanism, for example, the temperature inside the recording apparatus may become higher than the environmental temperature, thereby it is difficult to accurately obtain a calibration value.

### SUMMARY

According to an aspect of the present disclosure, a recording apparatus includes a recording head configured to discharge a liquid onto a recording medium to form an image, a heating unit configured to heat the recording medium, a first temperature sensor disposed in the recording head and configured to detect a temperature of the recording head, and a second temperature sensor configured to detect a temperature around the recording head, wherein a correction value for correcting the temperature of the recording head is calculated based on results of detection by the first temperature sensor and the second temperature sensor during a period from when the recording apparatus is powered on to when the heating unit is driven.

Further features of the present disclosure will become apparent from the following description of exemplary embodiments with reference to the attached drawings.

### BRIEF DESCRIPTION OF THE DRAWINGS

FIG. 1 is a schematic perspective view of an inkjet recording apparatus.

FIG. 2 is a cross-sectional view of the inkjet recording apparatus.

FIG. 3 is a block diagram of a control system in the recording apparatus.

FIG. 4 is a schematic diagram of a recording head.

FIGS. 5A and 5B are perspective views of the recording head.

FIG. 6 is a flowchart for describing head temperature correction according to one or more aspects of the present disclosure.

FIG. 7 is a flowchart for describing head temperature correction according to one or more aspects of the present disclosure.

FIG. 8 is a flowchart for describing head temperature correction according to one or more aspects of the present disclosure.

FIG. 9 is a flowchart for describing head temperature correction according to one or more aspects of the present disclosure.

FIG. 10 is a flowchart illustrating a process of calculating a corrected temperature.

### DESCRIPTION OF THE EMBODIMENTS

Hereinafter, an exemplary embodiment of the present disclosure will be described with reference to the drawings.

As an example of a recording apparatus, a recording apparatus using an inkjet recording method will be described below. The recording apparatus may be a single-function printer having only a recording function, or a multi-function printer having a plurality of functions such as a recording function, a fax function, and a scanner function. Alternatively, the recording apparatus may also be a manufacturing apparatus for manufacturing color filters, electronic devices, optical devices, microstructures, and the like, by a predetermined recording method.

In the following description, the term “recording” refers not only to formation of significant information, such as characters and figures, but also to the formation of insignificant information. Furthermore, the information may be manifest so that a human can visually recognize the information, or may not be manifest. The term also refers to the formation of images, designs, patterns, structures, and the like on a recording medium, or to processing of the medium, in a broad sense.

The term “recording medium” refers not only to paper used in general recording apparatuses, but also to a medium that can accept ink, such as a cloth, a plastic film, a metal plate, glass, ceramics, a resin, wood, and leather. In particular, the term “non-permeable recording medium/low-permeable recording medium” refers to a non-absorbent recording medium/low-absorbent recording medium. Examples of the non-permeable recording medium include a recording medium that is not produced as a recording medium for aqueous inkjet ink, such as glass, plastic, film, and Yupo (registered trademark). Examples of the non-permeable recording medium also include a recording medium that is not surface-treated for inkjet printing, i.e., has no ink-absorbing layer formed thereon, such as a plastic film and a base material, such as paper, coated with plastic. Examples of the plastic include polyvinyl chloride, polyethylene terephthalate, polycarbonate, polystyrene, polyurethane, polyethylene, and polypropylene. Examples of the low-permeable recording medium include a recording medium that is an actual printing stock used in offset printing, such as art paper and coated paper.

An actual printing stock (poorly absorbent recording medium) that has very low permeability to water-based ink compared to inkjet paper will be described. The actual printing stock is official (genuine) printing paper used in final offset printing to make a product. The printing paper is made from pulp, and uncoated paper is used as it is without being treated while coated paper is applied with a smooth coating of white pigments or the like on surfaces thereof. The coated paper is more susceptible to image defects due to ink overflow and drying failure in inkjet recording. A coating layer is a mixture of a sizing agent (such as a synthetic resin) that limits the liquid absorption property of gaps in the pulp and prevents bleeding of water-based ink, a filler (such as kaolin) that improves opacity, whiteness, smoothness, and the like, and a paper strengthening agent (such as starch), which is applied at a rate of about several to 40 g/m². An average capillary pore diameter of the coated paper is normally distributed around 0.06 μm, and moisture permeates through a large number of capillaries (capillary action). However, because the pore volume thereof is much smaller than that of inkjet paper, the coated paper is low in permeability to water-based ink, and thus the ink is caused to overflow on a sheet surface, resulting in noticeable image defects and drying failure.

A polyvinyl chloride sheet, which has no permeability to water-based ink compared to inkjet paper, will be described. The polyvinyl chloride sheet is a soft sheet that is made from a vinyl chloride resin as the main material, to which a plasticizer is added, and is excellent in printability in gravure printing and screen printing, and in emboss workability (creating an embossed pattern). Combining such printability and emboss workability enables a wide variety of expressions, so that the polyvinyl chloride sheet is used for many products, such as tarpaulins, canvas, and wallpaper. Since the main material of the polyvinyl chloride sheet is the vinyl chloride resin, the polyvinyl chloride sheet has no permeability to water-based ink, and may cause the ink to overflow on the sheet surface, resulting in noticeable image defects and drying failure.

Other examples of the low-permeable recording medium include a recording medium that is not produced as a recording medium for aqueous inkjet ink, such as glass, plastic, film, and Yupo (registered trademark). Other examples include recording medium that is not surface-treated for inkjet printing, i.e., has no ink-absorbing layer formed thereon, such as a plastic film and a base material, such as paper, coated with plastic. Examples of the plastic include polyvinyl chloride, polyethylene terephthalate, polycarbonate, polystyrene, polyurethane, polyethylene, and polypropylene.

The term “ink” is to be interpreted broadly in the same manner as the definition of “recording” above. Therefore, the term “ink” refers to a liquid that can be applied to a recording medium to form an image, design, pattern, or the like, or to process the recording medium, or to process ink (for example, to solidify or insolubilize a coloring material in the ink to be applied to the recording medium).

### (Overall Configuration)

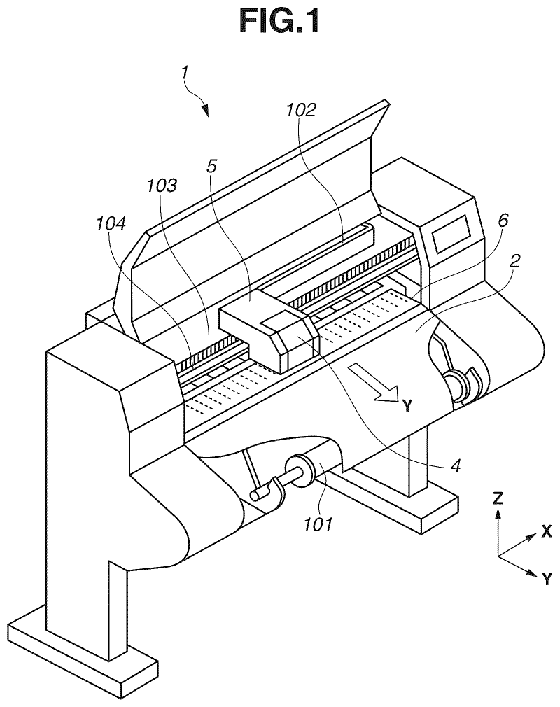

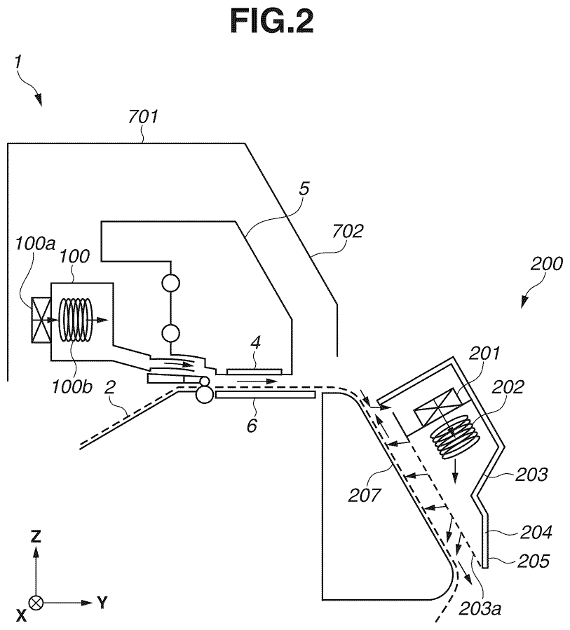

A configuration of an inkjet recording apparatus 1 and an outline of operation of the inkjet recording apparatus 1 during recording will be described with reference to FIGS. 1, 2A, and 2B. FIG. 1 is a diagram illustrating an external appearance of the inkjet recording apparatus 1 (hereinafter, also simply referred to as a recording apparatus 1) according to the present exemplary embodiment. FIG. 2 is a schematic cross-sectional view of the recording apparatus 1 as viewed from an X direction.

A recording medium 2 is conveyed in a Y direction from a spool 101 holding the recording medium 2 by a conveyance roller driven via gears by a conveyance motor (not illustrated). The fed recording medium 2 is pinched and conveyed between a paper feed roller and a pinch roller, and is guided to a recording position (scanning area of a recording head 4) on a platen 6. The platen 6 suctions air from a suction port (not illustrated) in order to prevent the recording medium 2 from floating up. The recording medium 2 guided onto the platen 6 is conveyed in the Y direction while being suctioned to the platen 6. Herein, with regard to a direction in which the recording medium 2 is conveyed, a forward direction, i.e., a direction from the platen 6 toward a paper ejection guide 207 described below, will be referred to as “downstream in the conveyance direction”. An opposite direction of the conveyance direction, i.e., a direction from the paper ejection guide 207 toward the platen 6, will be referred to as “upstream in the conveyance direction”.

A carriage unit 5 is driven by a carriage motor (not illustrated) to perform a reciprocating scan (reciprocating movement) in the X direction orthogonal to the Y direction along a guide shaft 104 extending in the X direction. The carriage unit 5 is equipped with the recording head 4. The recording head 4 is connected to an ink tank (not illustrated) and discharges ink supplied from the ink tank through a plurality of nozzles (discharge ports) provided on a bottom surface of the recording head 4. During a scanning process by the carriage unit 5, the nozzles of the recording head 4 discharge the ink at a timing based on a position signal obtained by an encoder 103, thereby to perform recording of a certain bandwidth corresponding to an arrangement area of the discharge ports. Then, the recording medium 2 is conveyed, and recording of the next bandwidth is performed. In this manner, the conveyance of the recording medium 2 and the recording scanning by the recording head 4 are alternately performed, so that a desired image is recorded on the recording medium 2.

The recording apparatus 1 includes a platen blower unit 100 that blows air to the scanning area of the recording head 4. The platen blower unit 100 includes a platen blower fan 100a and a heater 100b. The air fed by the fan 100a into the platen blower unit 100 is heated by the heater 100b to a predetermined temperature and is blown to the platen 6. When the recording medium 2 is present on the platen 6, the air blown from the platen blower unit 100 is blown to the recording medium 2. The air blown from the platen blower unit 100 accelerates evaporation of moisture in the ink applied to the recording medium by the recording head 4. In addition, the air blown by the platen blower unit 100 can remove a mist of ink that is generated in the vicinity of the recording head 4 during a recording operation by the recording head 4. The platen blower unit 100 does not necessarily have to include the heater 100b, and the air suctioned into the platen blower unit 100 by the platen blower fan 100a may be blown directly to the recording medium 2 without being heated.

The recording head 4, the carriage unit 5, the platen blower unit 100, and the platen 6 are disposed inside a housing 701, and an access cover 702 is disposed on a side face in a +Y direction of the housing 701 (a front face side of the recording apparatus 1). The access cover 702 is turnable between an opened position where the inside of the housing 701 is exposed and a closed position where the inside of the housing 701 is not exposed.

The recording medium on which the recording has been performed by the recording head 4 is conveyed downstream in the conveyance direction and reaches a fixing unit 200 that is arranged downstream in the conveyance direction of the scanning area of the recording head 4. The recording apparatus 1 includes the paper ejection guide 207 downstream of the platen 6 in the conveyance direction. The paper ejection guide 207 supports the back side of the recording medium 2 having passed the platen 6 until the recording medium 2 then passes the fixing unit 200. The fixing unit 200 is arranged downstream of the housing 701 in the conveyance direction. The fixing unit 200 and the housing 701 are spaced apart in the conveyance direction. The fixing unit 200 includes a fan 201, a heater 202, a chamber 203, and a heat insulating material 204. The fixing unit 200 uses the heater 202 to heat the air blown by the fan 201 into the chamber 203, and blows the heated air onto the recording medium 2 through a plurality of blowholes or slits provided in a chamber bottom 203a. This evaporates water and solvent contained in the ink on the recording medium 2. The width of the fixing unit 200 in the X direction is set to be larger than the maximum width of the recording medium 2 in the X direction on which recording can be performed by the recording head 4 in the recording apparatus 1. This improves uniformity of the temperature and wind speed of the hot air blown onto the recording medium 2.

The ink used in the present exemplary embodiment contains water-soluble resin microparticles to bring the coloring material into close contact with the recording medium 2 and improve the abrasion resistance (fixability) of a recorded image. The resin microparticles melt under heat, and the fixing unit 200 forms a film of the resin microparticles and dries the solvent contained in the ink. In the present exemplary embodiment, the term “resin microparticles” refers to polymer microparticles that exist in a dispersed state in water.

The heater 202 may be an open coil-type heater with nichrome wire held by mica or insulator (not illustrated) or a sheathed heater. The heater 202 is separated from surfaces constituting the chamber 203, and one heater 202 is disposed for each fan 201 to form a set. The air blown by the fan 201 is heated by the heater 202 and turns into hot air. A plurality of sets of the fan 201 and the heater 202 is disposed in the width direction of the recording apparatus 1, i.e., in the X direction. The heat insulating material 204 is disposed between the chamber 203 and an exterior 205 that covers an outer periphery of the chamber 203, thereby to suppress the outside of the exterior 205 from becoming hot even if the inside of the chamber 203 becomes hot.

### (Control Unit)

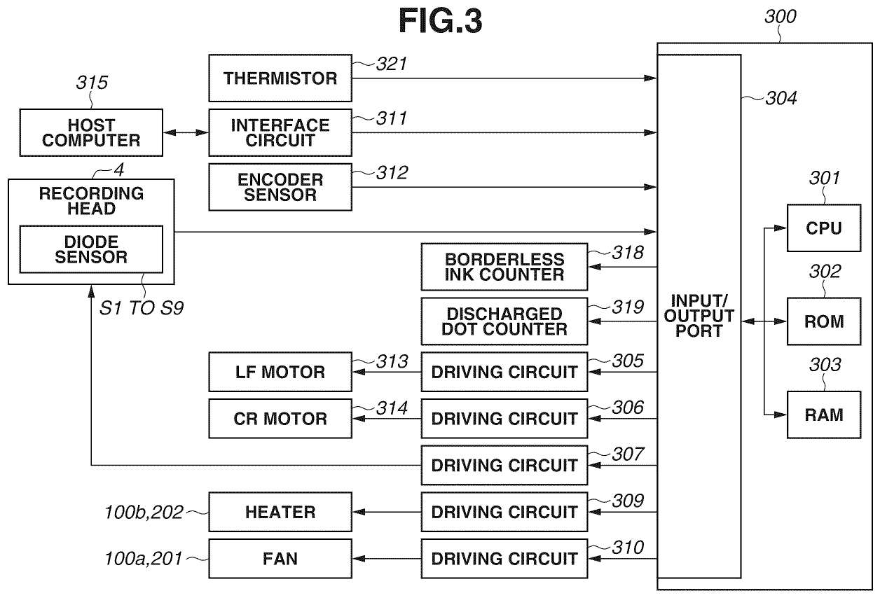

FIG. 3 is a block diagram illustrating a configuration of a control system that is installed in a main body of the inkjet recording apparatus 1 according to the present exemplary embodiment. A main control unit 300 includes a central processing unit (CPU) 301 that executes processing operations such as calculation, control, determination, and setting. The main control unit 300 also includes a read only memory (ROM) 302 that stores a control program to be executed by the CPU 301, a buffer that stores binary recording data indicating whether to discharge or not to discharge ink, a random access memory (RAM) 303 that is used as a work area for the CPU 301 to perform processing, an input/output port 304, and the like. The RAM 303 can also be used as a storage unit that stores information on the amounts of ink in a main tank before and after a recording operation and on a free space in a sub-tank. The input/output port 304 is connected to driving circuits 305 to 310 that respectively drive a conveyance motor (linear feed (LF) motor) 313 for driving a conveyance roller, a carriage motor 314, the recording head 4, the fans 100a and 201, and the heaters 100b and 202. These driving circuits 305 to 310 are controlled by the main control unit 300. The input/output port 304 are connected to various sensors, such as diode sensors S1 to S9 that detect the temperature of the recording head 4, an encoder sensor 312 fixed to the carriage unit 5, and a thermistor 321 that detects the ambient temperature (environmental temperature) inside the recording apparatus 1.

The main control unit 300 is connected to a host computer 315 via an interface circuit 311.

A borderless ink counter 318 counts the amount of ink discharged outside a recording medium when borderless recording is performed, and a discharged dot counter 319 counts the amount of ink discharged during printing.

### (Recording Head)

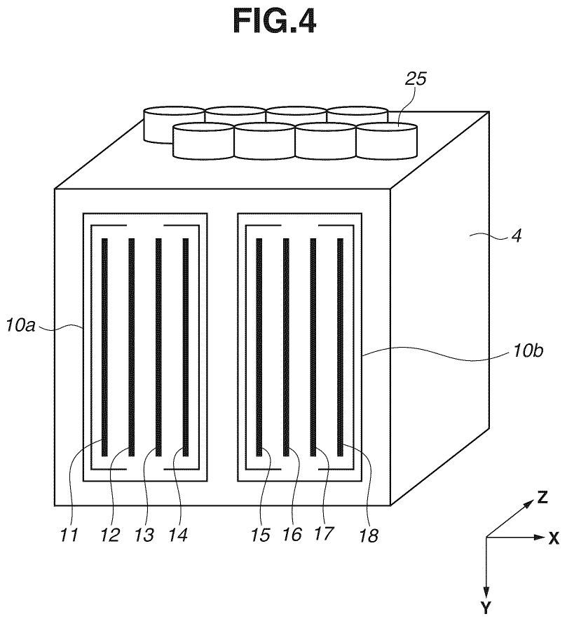

FIG. 4 is a schematic perspective view of the recording head 4. Two recording element substrates 10a and 10b formed of semiconductors or the like are attached to a discharge port formed surface of the recording head 4, which is the surface facing a recording medium 2. The recording element substrates 10a and 10b each have discharge port arrays in which discharge ports are arranged in the Y direction orthogonal to the X direction. More specifically, the recording element substrate 10a has a discharge port array 11 for discharging black ink, a discharge port array 12 for discharging gray ink, a discharge port array 13 for discharging light gray ink, and a discharge port array 14 for discharging light cyan ink, which are arranged in the X direction. The recording element substrate 10b has a discharge port array 15 for discharging cyan ink, a discharge port array 16 for discharging light magenta ink, a discharge port array 17 for discharging magenta ink, and a discharge port array 18 for discharging yellow ink, which are arranged in the X direction.

As will be described below, recording element arrays are formed at positions in the recording element substrates 10a and 10b that face the corresponding discharge port arrays 11 to 18. For the sake of simplicity, in the following description, the recording element arrays that are positioned to face the corresponding discharge port arrays 11 to 18 will be referred to as recording element arrays 11′ to 18′.

To the recording head 4, a flexible wiring substrate (not illustrated) is attached to supply a signal pulse for driving a recording element disposed inside a discharge port, a signal for adjusting the head temperature, and the like. One end of the flexible wiring substrate is connected to the recording head 4, and the other end is connected to the above-described main control unit 300. The thermistor 321, which is a temperature sensor that detects the ambient temperature inside the recording apparatus 1, is disposed in the vicinity of the main control unit 300. In the present exemplary embodiment, disposing the thermistor 321 in the vicinity of the main control unit 300 makes it possible to detect a temperature close to the temperature outside the recording apparatus 1.

On the recording head 4, joint parts 25 are disposed to be connected to a plurality of ink supply tubes (not illustrated) for supplying ink to the discharge port arrays 11 to 18. The ink supply tubes connected to the respective joint parts 25 are connected to a plurality of independent main tanks (not illustrated) corresponding to ink colors, thereby to supply ink from the main tanks to the recording head 4.

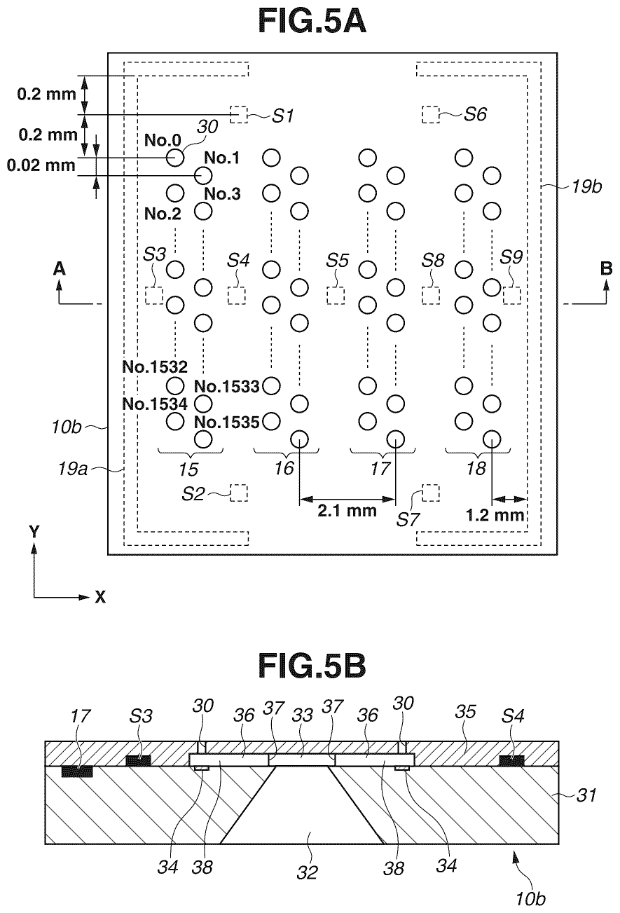

FIG. 5A is a perspective view of the recording element substrate 10b as seen from a direction perpendicular to the XY plane. FIG. 5B is a cross-sectional view of the recording element substrate 10b taken perpendicularly along a line segment AB illustrated in FIG. 5A, illustrating a state of the discharge port array 15 and its vicinity as seen from the downstream side in the Y direction. Since the configuration of the recording element substrate 10a is identical to that of the recording element substrate 10b, the recording element substrate 10b will be described below. A specific numerical value of a dimension, a distance, or the like described below may be set as appropriate depending on dimensions of the recording element substrates 10a and 10b.

In the recording element substrate 10b, a total of nine diode sensors S1 to S9 are formed as temperature sensors for detecting the temperature of ink in the vicinity of a recording element 34. The diode sensors S1 and S6 are arranged near end portions on one side of the discharge port arrays 15 to 18 in the Y direction. More specifically, the diode sensors S1 and S6 are arranged at positions 0.2 mm away from the discharge ports at the end portions on one side in the Y direction. The diode sensor S1 is arranged midway between the discharge port arrays 15 and 16 in the X direction, and the diode sensor S6 is arranged midway between the discharge port arrays 17 and 18 in the X direction.

The diode sensors S2 and S7 are arranged near end portions on the other side of the discharge port arrays 15 to 18 in the Y direction, across the discharge port arrays 15 to 18 with respect to the diode sensors S1 and S6. The diode sensor S2 is arranged midway between the discharge port arrays 15 and 16 in the X direction, and the diode sensor S7 is arranged midway between the discharge port arrays 17 and 18 in the X direction. More specifically, the diode sensors S2 and S7 are arranged at positions 0.2 mm away from the discharge ports at the end portions on the other side in the Y direction.

The diode sensors S3, S4, S5, S8, and S9 are arranged in a central part of the discharge port arrays 15 to 18 in the Y direction. The diode sensor S4 is arranged midway between the discharge port arrays 15 and 16 in the X direction, the diode sensor S5 is arranged midway between the discharge port arrays 16 and 17 in the X direction, and the diode sensor S8 is arranged midway between the discharge port arrays 17 and 18 in the X direction. The diode sensor S3 is arranged on an outer side of the discharge port array 15 in the X direction, and the diode sensor S9 is arranged on an outer side of the discharge port array 18 in the X direction.

The number of diode sensors arranged on the recording element substrate 10b is not limited to nine. For example, if more diode sensors are disposed on the recording element substrate 10b, the number of points at which the temperature is detected increases, so that the temperature of the recording head 4 can be grasped more accurately. In addition, in general, the central part of the discharge port arrays is less likely to dissipate heat than the ends of the discharge port array, so that the temperature is more likely to rise in the center of the discharge port array. Therefore, more diodes may be arranged in the center where the temperature is more likely to rise, such that the temperature can be grasped more precisely. Furthermore, if precise temperature control is desired, it is preferable to arrange more diodes densely for one discharge port array. The number and arrangement of diodes in the product can be determined from the above viewpoints and in terms of cost.

On the recording element substrate 10b, heating elements (hereinafter also referred to as sub-heaters) 19a and 19b are disposed to increase the temperature of ink inside the discharge ports. The heating element 19a is formed of a continuous member surrounding a side of the discharge port array 15 in the X direction on which the diode sensor S3 is disposed. Similarly, the heating element 19b is formed of a continuous member surrounding a side of the discharge port array 18 in the X direction on which the diode sensor S9 is disposed. The heating elements 19a and 19b are positioned 1.2 mm outward from the discharge port arrays 15 and 19 in the X direction and 0.2 mm outward from the diode sensors S1, S2, S6, and S7 in the Y direction.

The recording element substrate 10b includes a substrate 31 on which various circuits in addition to the diode sensors S1 to S9 and the sub-heaters 19a and 19b are formed, and a discharge port member 35 that is formed of a resin. A common ink chamber 33 is formed between the substrate 31 and the discharge port member 35, and an ink supply port 32 communicates with the common ink chamber 33. From the common ink chamber 33, an ink flow path 36 extends, and the ink flow path 36 communicates with a discharge port 30 formed in the discharge port member 35. A bubbling chamber 38 is formed at the end of the ink flow path 36 on the discharge port 30 side, and the recording element (main heater) 34 is arranged in the bubbling chamber 38 at a position facing the discharge port 30. The recording element 34 does not necessarily have to be an electrothermal conversion element, and a piezoelectric element may be used. A nozzle filter 37 is formed between the ink flow path 36 and the common ink chamber 33.

In the present exemplary embodiment, a representative temperature is calculated based on temperatures detected by the diode sensors S1 to S9, and various temperature controls are performed based on the representative temperature. In the following description, for the sake of simplicity, the temperature detected by the diode sensor S5 will be used as the representative temperature in various temperature controls. However, the present exemplary embodiment is not limited to such a mode in which the detected temperature from a single diode sensor is always used in common in all the temperature controls. For example, there may be adopted a mode in which a combination of temperature sensors used to calculate the representative temperature is changed for each type of temperature control. As an example, in the case of performing drive pulse control that controls a drive pulse applied to a recording element in accordance with the temperature in the recording element array 15′, there may be adopted a mode in which an average value of the temperatures detected by the four surrounding diode sensors S1, S2, S3, and S4 is used as the representative temperature. Furthermore, in the case of performing the above-described drive pulse control in a recording element array 18′, the four surrounding diode sensors S6, S7, S8, and S9 may be used. In order to keep the ink warm during recording, a sub-heater heating control may be performed on the sub-heater 19a such that the sub-heater 19a is driven when the ink temperature is equal to or lower than a predetermined threshold, and driving of the sub-heater 19a is stopped when the ink temperature exceeds a predetermined threshold. In such a case, the minimum value of the temperatures detected by the three diode sensors S1, S2, and S3 in the vicinity of the sub-heater 19a may be set as the representative temperature. The present exemplary embodiment does not need to include a plurality of diode sensors in the recording head as illustrated in FIG. 5A, but at least one diode sensor.

### (Data Processing Process)

In the present exemplary embodiment, processes of recording data generation processing executed by the CPU 301 in accordance with the control program will be described.

First, the CPU 301 obtains image data (brightness data) represented by 8-bit 256-value information (0 to 255) for each color of red (R), green (G), and blue (B) input from the host computer 315 to the recording apparatus 1.

Next, the CPU 301 converts the image data represented by R, G, and B into multi-value data represented by a plurality of types of ink used for recording. The color conversion processing generates the multi-value data represented by the 8-bit 256-value information (0 to 255) that defines gradations of the ink for each pixel group constituted of a plurality of pixels.

Next, the CPU 301 quantizes the multi-value data described above to generate quantized data (binary data) represented by 1-bit binary information (0, 1) that determines whether to discharge or not to discharge each ink for each pixel. As quantization processing, here the processing can be performed by various quantization methods, such as the error diffusion method, the dither method, and the index method.

Then, the CPU 301 performs distribution processing to distribute the quantized data to a plurality of scans on a unit area of the recording head. By the distribution processing, recording data represented by 1-bit binary information (0, 1) that determines whether to discharge or not to discharge ink for each pixel in each of the plurality of scans on the unit area of the recording medium is generated. The distribution processing is performed using a mask pattern that corresponds to the plurality of scans and defines whether to permit or not permit ink discharge for each pixel.

The ink is discharged from the recording head in accordance with the recording data generated as described above.

In the mode described above, all of the above processing is executed by the CPU 301 in the recording apparatus 1, but the processing may be performed in other modes. For example, all of the above processing may be executed by the host computer 315. Alternatively, part of the processing may be executed by the host computer 315 and the rest by the recording apparatus 1, for example.

### (Ink Composition)

The composition of color ink and water-soluble resin microparticle ink used in the present exemplary embodiment will be described below. In the following description, expressions with the terms “parts” and “%” are based on mass unless otherwise specified.

Both the color ink that contains pigments and the water-soluble resin microparticle ink that does not contain pigments or contains only a very small quantity of pigments used in the present exemplary embodiment contain a water-soluble organic solvent. The water-soluble organic solvent desirably has a boiling point of 150° C. or higher and 300° C. or lower for the reasons of wettability and moisture retention of the head face surface. From the viewpoints of the function of a film-forming aid for the resin microparticles and swelling solubility in a recording medium on which a resin layer is formed, a ketone compound such as acetone and cyclohexanone, a propylene glycol derivative such as tetraethylene glycol dimethyl ether, a heterocyclic compound having a lactam structure, typified by N-methyl-pyrrolidone and 2-pyrrolidone, are particularly desirable. From the viewpoint of discharge performance, the content of the water-soluble organic solvent is desirably 3 wt % or more and 30 wt % or less. Specific examples of the water-soluble organic solvent include: alkyl alcohols having 1 to 4 carbon atoms, such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones or ketoalcohols such as acetone and diacetone alcohol; ethers such as tetrahydrofuran and dioxane; polyalkylene glycols such as polyethylene glycol and polypropylene glycol; ethylene glycol; alkylene glycols in which the alkylene group contains 2 to 6 carbon atoms, such as propylene glycol, butylene glycol, triethylene glycol, 1,2,6-hexanetriol, thiodiglycol, hexylene glycol, and diethylene glycol; lower alkyl ether acetates such as polyethylene glycol monomethyl ether acetate; glycerin, lower alkyl ethers of polyhydric alcohols such as ethylene glycol monomethyl (or ethyl) ether, diethylene glycol methyl (or ethyl) ether, and triethylene glycol monomethyl (or ethyl) ether; polyhydric alcohols such as trimethylolpropane and trimethylolethane; N-methyl-2-pyrrolidone; 2-pyrrolidone; and 1,3-dimethyl-2-imidazolidinone. The water-soluble organic solvents as described above can be used singly or in mixture. As the water, deionized water is desirably used. In addition to the above-described components, a surfactant, defoamer, preservative, antifungal agent, and the like may be added as appropriate to the color ink and the water-soluble resin microparticle ink used in the present exemplary embodiment in order to impart the desired physical property values to the ink.

### Preparation of Resin Microparticle Dispersion Liquid

The color ink of the present exemplary embodiment contains water-soluble resin microparticles to bring the recording medium and the coloring material into close contact with each other and to improve the abrasion resistance (fixability) of the recorded image. The resin microparticles are melted under heat, and a heater is used to form a film of the resin microparticles and to dry the solvent contained in the ink. In the present exemplary embodiment, the term “resin microparticles” refers to polymer microparticles that exist in a dispersed state in water. Specifically, examples of the resin microparticles include: acrylic resin microparticles synthesized by emulsion polymerization of monomers such as (meth)acrylic acid alkyl esters or (meth)acrylic acid alkyl amides; styrene-acrylic resin microparticles synthesized by emulsion polymerization of monomers such as (meth)acrylic acid alkyl esters or (meth)acrylic acid alkyl amides and styrene; polyethylene resin microparticles; polypropylene resin microparticles; polyurethane resin microparticles; and styrene-butadiene resin microparticles. In addition, the resin microparticles may be core-shell resin microparticles in each of which the polymer composition differs between core and shell parts constituting a resin microparticle, and resin microparticles each obtained by emulsion polymerization of an acrylic particle synthesized in advance as a seed particle to control a particle diameter, or the like. Furthermore, the resin microparticles may be hybrid resin microparticles in each of which different resin microparticles, such as an acrylic resin microparticle and a urethane resin microparticle, are chemically bonded together.

The “polymer microparticles that exist in a dispersed state in water” may be provided in the form of resin microparticles obtained by homopolymerizing a monomer having a dissociable group or copolymerizing a plurality of kinds of monomers, i.e., in the form of a self-dispersing resin microparticle dispersion. Examples of the dissociable group include a carboxyl group, a sulfonic acid group, and a phosphoric acid group. Examples of the monomer having the dissociable group include acrylic acid, and methacrylic acid. Furthermore, the polymer microparticles may be provided in the form of an emulsified dispersion type resin microparticle dispersion in which the resin microparticles are dispersed by an emulsifier. As the emulsifier, a material having an anionic charge can be used regardless of whether the material has a low molecular weight or a high molecular weight.

### Treatment Liquid

In the present exemplary embodiment, a treatment liquid (reaction liquid) is used for the purpose of forming an image on a poorly absorbent or non-absorbent recording medium. The treatment liquid used in the present exemplary embodiment contains a reactive component that reacts with a pigment contained in the ink and causes the pigment to aggregate or gel. Specifically, the reactive component is a component that can destroy dispersion stability of ink having pigments stably dispersed or dissolved in an aqueous medium by action of an ionic group when being mixed with the ink on a recording medium or the like. In the present exemplary embodiment, an anionic coloring material is used, so that usable reactants can be broadly classified into acid-based reactants, polyvalent metal-based reactants, and cationic polymer-based reactants.

The acid-based reactants can be broadly classified into inorganic acids and organic acids. In the present exemplary embodiment, the organic acids are described, but the present disclosure is not limited to the organic acids. Specific examples of water-soluble organic acids include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, oxysuccinic acid, and dioxysuccinic acid. The content of the organic acids is desirably 3.0% by mass or more and 90.0% by mass or less, and more desirably 5.0% by mass or more and 70.0% by mass or less, based on the total mass of the composition contained in the treatment liquid.

The following metallic ions are desirable as the polyvalent metal-based reactants. Examples thereof include divalent metallic ions such as Ca2+, Cu2+, Ni2+, Mg2+, Zn2+, Sr2+, and Ba2+. In addition, examples thereof also include trivalent metallic ions such as Al3+, Fe3+, Cr3+, and Y3+, but the polyvalent metal-based reactants are not limited to them. In order to contain such polyvalent metallic ions in the treatment liquid, it is recommended to use a polyvalent metal salt. The salt is a metallic salt constituted of the polyvalent metallic ions as described above, and an anion that binds to these ions. The salt is required to be soluble in water. Examples of desirable anions for forming the salt include, but are not limited to, Cl—, NO3-, I—, Br—, ClO3-, SO42-, CO32-, CH3COO—, and HCOO—.

In the present disclosure, the polyvalent metallic ions are particularly desirably Ca2+, Mg2+, Sr2+, Al3+, or Y3+ from the viewpoints of reactivity, colorability, ease of handling, and the like, and among them, Ca2+ is particularly desirable. As the anion for forming a salt with the polyvalent metallic ions, methanesulfonic acid is particularly desirable from the viewpoint of safety and the like.

The cationic polymer-based reactant is desirably soluble in water. Specific examples of cationic polymers include polyallylamine hydrochloride, polyamine sulfonate, polyvinylamine hydrochloride, and chitosan acetate. In addition, examples include copolymers of vinylpyrrolidone and aminoalkyl alkylate quaternary salts, in which a part of a nonionic polymeric substance is cationized, and copolymers of acrylamide and aminomethyl acrylamide quaternary salts. The treatment liquid containing a cationic polymer as a reactive component is desirably colorless, but does not necessarily have to be one that does not exhibit absorption in the visible range.

More specifically, even if the treatment liquid exhibits absorption in the visible range, the treatment liquid may be a light-colored liquid that exhibits absorption in the visible range as long as it does not substantially affect an image in a case where the image is formed. The treatment liquid does not necessarily need to be used in all recording modes, and only an amount of the treatment liquid necessary for forming a print image is given in consideration of the amount of ink applied.

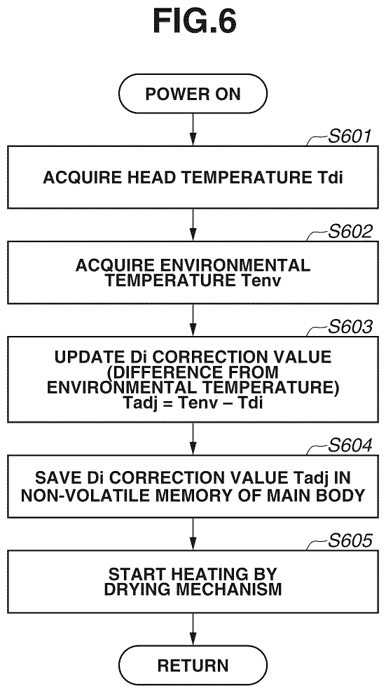

A processing flow of head temperature correction in the present exemplary embodiment will be described below with reference to FIG. 6. The processing flow of the head temperature correction in the present exemplary embodiment is executed when the recording apparatus 1 is supplied with power, i.e., when the recording apparatus 1 is powered on, and a correction value for the recording head temperature (hereinafter, referred to as Di correction value) is calculated.

First, in step S601 illustrated in FIG. 6, a detected temperature Tdi is acquired from the diode sensor S5 disposed in the recording head 4. In this example, the temperature acquired from the diode sensor S5 arranged in the center of the recording element substrate 10b is simply used as the detected temperature Tdi. Alternatively, as described above, the average value of the detected temperatures from a plurality of diode sensors may be used as the detected temperature Tdi. Information indicating the acquired detected temperature Tdi is stored in the RAM 303. In step S602, a detected temperature Tenv is acquired from the thermistor 321. Information indicating the acquired detected temperature Tenv is stored in the RAM 303. The detected temperature Tenv here indicates the ambient temperature inside the recording apparatus 1 as described above.

In step S603, a difference between the detected temperature Tdi from the diode sensor S5 and the detected temperature Tenv from the thermistor 321, which were acquired in steps S601 and S602, is calculated and set as a Di correction value Tadj. In step S604, the calculated Di correction value Tadj is saved in the ROM 302. After completion of step S604, in step S605, the platen blower unit 100 and the fixing unit 200 are powered on to start preparation for printing.

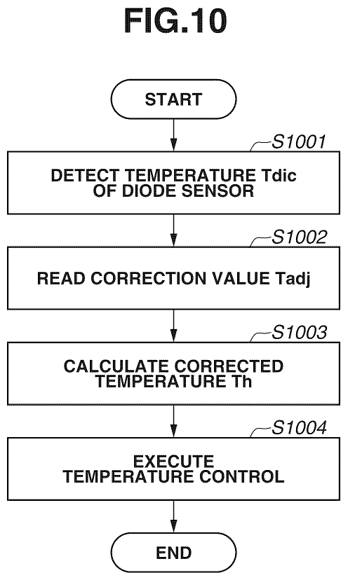

Next, a method for applying the Di correction value Tadj calculated in the processing flow of head temperature correction will be described. FIG. 10 is a flowchart illustrating a process of acquiring a corrected temperature at execution of the temperature control of the recording head 4. In the following description, for the sake of simplicity, the temperature acquired from the diode sensor at the execution of the temperature control is denoted as Tdic, and the corrected temperature after correction is denoted as Th. In step S1001 of FIG. 10, the temperature Tdic detected by the diode sensor S5 is acquired immediately before the execution of the temperature control. In step S1002, the Di correction value Tadj is read from the ROM 302.

In step S1003, the corrected temperature Th is calculated according to Formula 1 described below to correct the temperature detected by the diode sensor:

Th=Tdic+Tadj (Formula 1)

At the calculation of the correction value in the processing flow of the head temperature correction of FIG. 6, when the temperature detected by the thermistor 321 is higher than the temperature detected by the diode sensor S5, the corrected temperature Th calculated in step S1003 will be higher than the temperature Tdic before correction (Th >Tdic). Conversely, at the calculation of the correction value in the processing flow of the head temperature correction of FIG. 6, when the temperature detected by the thermistor 321 is lower than the temperature detected by the diode sensor S5, the corrected temperature Th calculated in step S1003 will be lower than the temperature Tdic before the correction (Th<Tdic).

Then, in step S1004, the calculated corrected temperature Th is used to perform the temperature control of the recording head 4. The temperature control herein can be a driving pulse control, a sub-heater heating control, a short pulse heating control, or the like, for example.

With the above configuration, before a heating mechanism starts heating, appropriate correction processing can be performed based on the detection results from the diode sensor S5 and thermistor 321. At the time of power-on, the heating mechanism needs to warm up from a state of being adapted to the outside air temperature to a target temperature, so it is desirable for the heating mechanism to start heating as soon as possible after the recording apparatus 1 is powered on. However, if the heating mechanism starts heating before the head temperature correction, the temperature of the recording head 4 and the ambient temperature inside the apparatus may rise due to an effect of the temperature rise in the heating mechanism. As a result, the head temperature correction may not be performed correctly.

In the present exemplary embodiment, the head temperature correction (Di correction) is performed before a drying mechanism including the heating mechanism starts heating, and the Di correction is performed in a state where the temperature of the recording head 4 and the ambient temperature inside the apparatus are not affected by the temperature rise in the heating mechanism, so that the temperature of the recording head 4 can be calibrated with high accuracy.

The processing flow of the head temperature correction illustrated in FIG. 6 is started at the time of power-on of the recording apparatus 1 because, in the power-off state, neither the recording head 4 nor the drying mechanism is in operation, so that the processing flow can be started in a state where there is no temperature rise due to printing or drying. However, in consideration of a case where printing or drying has been performed up until powering off of the apparatus and then the apparatus is powered on immediately after the power-off, it is better to add determination on whether to perform the correction depending on whether the apparatus has been powered-off for a predetermined period of time or more.

A second exemplary embodiment will be described below, but descriptions of components identical to those of the first exemplary embodiment will be omitted. In the first exemplary embodiment, the Di correction is performed before the drying mechanism starts heating, thereby the temperature correction is performed while the influence of the temperature rise due to heating is eliminated. In the present exemplary embodiment, a temperature sensor installed in a drying mechanism is used to determine whether to perform a Di correction.

A platen blower unit 100 includes a heater 100b and a platen blower fan 100a, and further includes a sensor (not illustrated) that detects the temperature of blown air. Since the platen blower unit 100 is positioned closer to a recording head 4 than a thermistor 321, the temperature acquired from the sensor included in the platen blower unit 100 is used to calculate a Di correction value. This makes it possible to more accurately estimate the temperature of the recording head 4.

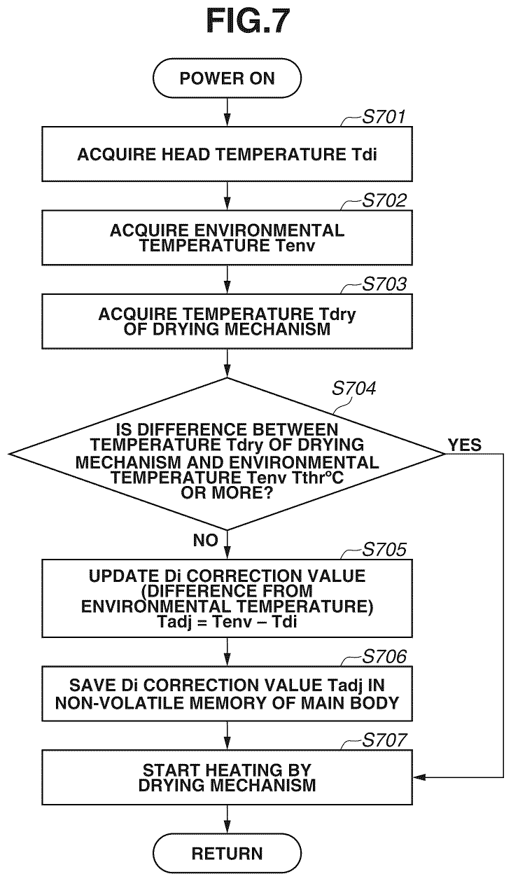

FIG. 7 illustrates a processing flow of head temperature correction in the present exemplary embodiment. In steps S701 and S702, as in the first exemplary embodiment, a detected temperature Tdi from a diode sensor S5 and a detected temperature Tenv from the thermistor 321 are acquired and stored in a RAM 303. In step S703, a detected temperature Tdry from the temperature sensor installed in the platen blower unit 100 is acquired. The temperature sensor installed in the platen blower unit 100 is desirably a thermistor, as in the case of a sensor for obtaining the ambient temperature.

Next, in step S704, a difference between the temperature Tdry from the drying mechanism acquired in step S703 and the environmental temperature Tenv acquired in step S702 is calculated. Comparing the environmental temperature Tenv that is close to the air temperature outside the recording apparatus with the temperature Tdry that is the ambient temperature at a position close to the recording head 4 makes it possible to determine whether the temperature inside the recording apparatus 1 has risen compared to the outside air temperature. If the absolute value of the difference between the temperature Tenv and the temperature Tdry is less than a predetermined temperature Tthr (NO in step S704), it is determined that the temperature inside the recording apparatus 1 has not risen compared to the outside air temperature, and the Di correction is performed in steps S705 and S706 in the same manner as in steps S603 and S604 in FIG. 6. On the other hand, if the difference between the temperature Tenv and the temperature Tdry is equal to or greater than the temperature Tthr (YES in step S704), the Di correction is not performed, and the processing proceeds to step S707. In step S707, the drying mechanism starts heating. The value of the temperature Tthr herein is set to a value that does not to exceed the temperature Tthr due to a detection error or detection variation of the temperatures Tenv and Tdry. For example, if the detection error or detection variation of the temperatures Tenv and Tdry is +0.5° C., the temperature Tthr is set to be greater than 1.0° C., so that the determination can be performed favorably without being influenced by noise, such as a detection variation. Processing of applying the calculated correction value is the same as the processing in the first exemplary embodiment, and thus a description thereof will be omitted.

According to the above method, since the ambient temperature near the recording head 4 is compared with the temperature of the thermistor 321 positioned close to the outside air in the recording apparatus 1, it is possible to determine whether the temperature inside the recording apparatus 1 has risen before calculation of the Di correction value. Therefore, if it is determined that the absolute value of the difference between the temperature inside the recording apparatus 1 and the ambient temperature is equal to or greater than the predetermined value, the Di correction is not performed at this time but is performed at the time of next or subsequent power-on. If the absolute value of the difference between the temperature inside the recording apparatus 1 and the ambient temperature is less than the predetermined value, the Di correction is performed. When the actual temperature of the recording apparatus 1 is higher than the outside air temperature, if the temperature of the recording head 4 is corrected on an assumption that the temperature of the recording apparatus 1 is equal to the outside air temperature, the temperature of the recording head 4 is recognized as being lower than an actual temperature. In such a case, if control is performed to heat the recording head 4 to the target temperature, the recording head 4 will be heated to a temperature higher than the target temperature.

Such excessive heating may impose a load on the recording head 4, thereby affecting printing. In addition, since the amount of ink discharged is controlled to be constant by changing the pulse for ink discharge according to the temperature of the recording head 4, the head temperature may be recognized with a large error from the actual head temperature, and the amount of ink discharged may not be appropriate.

On the other hand, when it is determined that the temperature inside the recording apparatus 1 is within a predetermined range from the outside air temperature, the Di correction is performed. As a result, the Di correction can be performed with high accuracy.

In the flowchart illustrated in FIG. 7, whether to perform the Di correction is determined at the time of power-on, but a range to which the flowchart in FIG. 7 is applicable is not necessarily limited to the time of power-on. If it can be determined that the temperature of the recording head 4 has not risen, for example, if a certain amount of time has elapsed since the previous printing, it is considered that the temperature of the recording head 4 has not risen due to printing, and therefore the temperature of the recording head 4 can be estimated to be in an equivalent state as that at the time of power-on.

Therefore, the processing in the flowchart of FIG. 7 may be started when a certain amount of time has elapsed since the previous printing.

A third exemplary embodiment will be described below, but descriptions of components identical to those of the first and second exemplary embodiments will be omitted. In the present exemplary embodiment, it is determined whether the temperature inside a recording apparatus is close to the temperature of the outside air by using an air blower mechanism and a temperature sensor installed in a drying mechanism. If Di correction is performed in a state where the temperature inside the recording apparatus is not yet adapted to the temperature of the outside air, the temperature inside the recording apparatus is detected to be equal to the outside air temperature even though the actual temperature is higher than the temperature of the outside air. This means that the temperature of a recording head is recognized as being lower than the actual temperature.

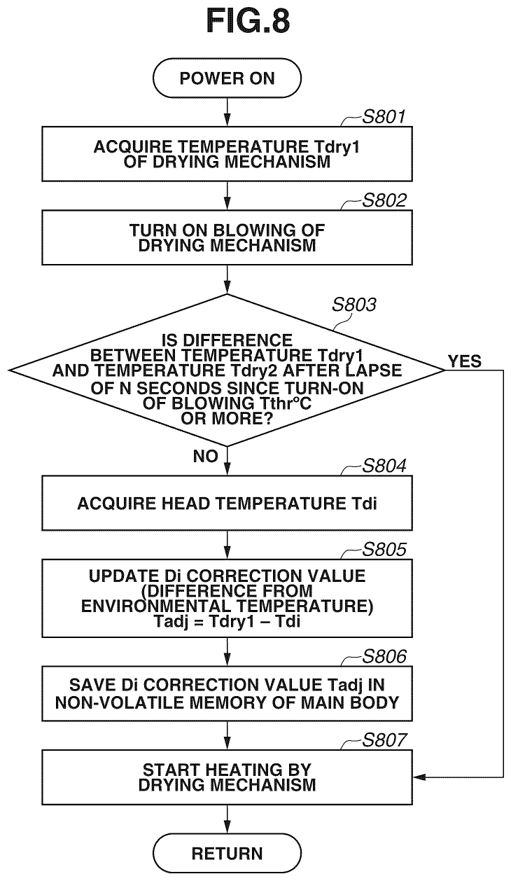

FIG. 8 illustrates a processing flow of head temperature correction in the present exemplary embodiment. In the present exemplary embodiment, as in the first exemplary embodiment, a Di correction value is calculated when a recording apparatus 1 is powered on. When the processing is started, in step S801, a temperature Tdry1 detected by the temperature sensor of the drying mechanism is acquired and stored in a RAM 303. Next, in step S802, only air blowing is performed by a platen blower unit 100. At this time, the platen blower unit 100 drives a platen blower fan 100a, and does not drive a heater 100b.

Then, in step S803, a temperature Tdry2 of the drying mechanism after the air blowing is performed for N seconds is obtained, and a difference from the temperature Tdry1 is calculated. If the absolute value of the difference between the temperatures Tdry1 and Tdry2 is less than a predetermined value Tthr (NO in step S803), the Di correction is performed in steps S804 to S806. On the other hand, if the difference between the temperatures Tdry1 and Tdry2 is equal to or greater than the predetermined value Tthr (YES in step S803), the Di correction is not performed, and the processing proceeds to step S807. In step S807, the heater 100b of the platen blower unit 100 is driven to start heating. The processing of applying the calculated correction value is the same as the processing in the first exemplary embodiment, and thus a description thereof will be omitted.

In the present exemplary embodiment, if the temperature of the outside air taken into the recording apparatus 1 by blowing the air from the platen blower unit 100 is significantly different from the temperature inside the recording apparatus 1, a temperature change from the temperature Tdry1 to the temperature Tdry2 becomes large. Conversely, if the temperature of the outside air and the temperature inside the recording apparatus 1 are substantially the same, the temperature change from the temperature Tdry1 to the temperature Tdry2 becomes small. In the present exemplary embodiment, the above is utilized to determine whether the ambient temperature inside the recording apparatus 1 has sufficiently adapted to the outside air temperature.

Therefore, it is desirable that the platen blower unit 100 in the present exemplary embodiment is configured to take in outside air or includes a mechanism that can adjust the amount of outside air taken in. In addition, in order to reduce the time (N seconds) from the start of air blowing to the determination, it is desirable that the amount of outside air taken in is set as large as possible when carrying out the processing flow of the present exemplary embodiment. As in the second exemplary embodiment, the start of the processing flow of the present exemplary embodiment is not limited to the time of power-on.

A fourth exemplary embodiment will be described below, but descriptions of components identical to those of the first to third exemplary embodiments will be omitted. In the present exemplary embodiment, the processing flows in the second and third exemplary embodiments are combined to more accurately determine whether the temperature inside a recording apparatus is adapted to the outside air temperature.

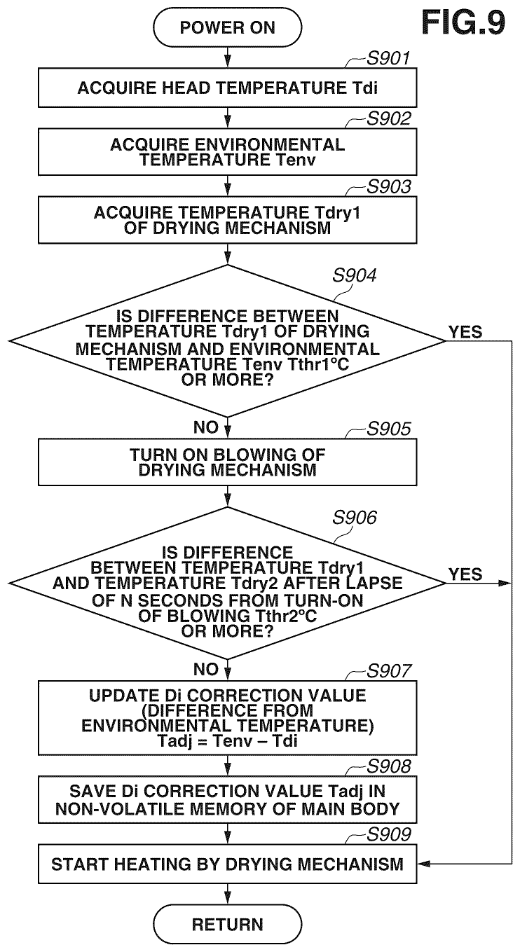

FIG. 9 illustrates a processing flow of head temperature correction in the present exemplary embodiment. First, in steps S901 to S903, a head temperature Tdi, an environmental temperature Tenv, and an temperature Tdry1 of a drying mechanism are acquired. Then, in step S904, a difference between the temperature Tdry1 of the drying mechanism and the environmental temperature Tenv is calculated. If the absolute value of the difference between the temperature Tdry1 of the drying mechanism and the environmental temperature Tenv is equal to or greater than a threshold temperature Tthr1 (YES in step S904), the Di correction is not performed, and the processing proceeds to step S909. In step S909, a platen blower unit 100 starts heating. If the absolute value of the difference between the temperature Tdry1 of the drying mechanism and the environmental temperature Tenv is smaller than the threshold temperature Tthr1 (NO in step S904), the processing proceeds to step S905. Step S905 and subsequent steps are identical to steps S803, and S805 to S807 in FIG. 8, and thus descriptions thereof will be omitted.

In the present exemplary embodiment, it is determined whether the head temperature can be corrected based on the comparison between the ambient temperature and the temperature of the drying mechanism as described in the second exemplary embodiment, and also based on the temperature change inside the recording apparatus between before and after air blowing as described in the third exemplary embodiment.

The configuration makes it possible to prevent correction of the head temperature when the ambient temperature and the temperature of the drying mechanism are substantially the same but both are higher than the outside air temperature, for example, so that it is possible to more accurately determine whether the temperature inside the recording apparatus is adapted to the outside air temperature. This improves the accuracy of head temperature correction.

Each of the first to fourth exemplary embodiments is not limited to a recording apparatus that includes the serial-type recording head 4 as illustrated in FIG. 1. For example, the present disclosure can also be applied to a full-line type recording apparatus in which a printing position of the recording head 4 is fixed and an image is printed on a recording medium while the recording medium is continuously conveyed while facing the recording head 4.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in a recording apparatus having a heating mechanism, the temperature of a recording head can be detected appropriately.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-211576, filed Dec. 14, 2023, which is hereby incorporated by reference herein in its entirety.

What is claimed is:

1. A recording apparatus comprising:
a recording head configured to discharge a liquid onto a recording medium to form an image;
a heating unit configured to heat the recording medium;
a first temperature sensor disposed in the recording head and configured to detect a temperature of the recording head; and
a second temperature sensor configured to detect a temperature around the recording head,
wherein a correction value for correcting the temperature of the recording head is calculated based on results of detection by the first temperature sensor and the second temperature sensor during a period from when the recording apparatus is powered on to when the heating unit is driven.

2. The recording apparatus according to claim 1, wherein the heating unit includes a heater configured to heat air, a fan configured to blow the air, and a third temperature sensor configured to detect a temperature of the air heated by the heater and blown by the fan.

3. The recording apparatus according to claim 2,
wherein a comparison is made between a second temperature detected by the second temperature sensor and a third temperature detected by the third temperature sensor during the period from when the recording apparatus is powered on to when the heating unit is driven, and in a case where a difference between the second temperature and the third temperature is less than a first value, the correction value is calculated, and
wherein, in a case where the difference is equal to or greater than the first value, the correction value is not calculated.

4. The recording apparatus according to claim 2,
wherein a comparison is made between a fourth temperature detected by the third temperature sensor before the fan of the heating unit is driven and a fifth temperature detected by the third temperature sensor after the fan of the heating unit is driven during the period from when the recording apparatus is powered on to when the heating unit is driven, and in a case where a difference between the fourth temperature and the fifth temperature is less than a second value, the correction value is calculated, and
wherein, in a case where the difference is equal to or greater than the second value, the correction value is not calculated.

5. The recording apparatus according to claim 1, wherein driving of the recording head is controlled based on the temperature of the recording head corrected based on the correction value.
